(19) United States
(12) Patent Application Publication
(10) Pub. No.: US 2014/0189769 A1
(43) Pub. Date: Jul. 3, 2014

(54) INFORMATION MANAGEMENT DEVICE, SERVER, AND CONTROL METHOD

(71) Applicants: Mitsuhiko Sakai, Hakui-shi (JP); KABUSHIKI KAISHA TOSHIBA, Tokyo (JP)

(72) Inventors: Masayuki Okamoto, Kanagawa (JP); Masaru Sakai, Tokyo (JP); Hiroko Fujii, Tokyo (JP); Daisuke Sano, Tokyo (JP)

(73) Assignee: KABUSHIKI KAISHA TOSHIBA, Tokyo (JP)

(21) Appl. No.: 14/042,046

(22) Filed: Sep. 30, 2013

Related U.S. Application Data
(63) Continuation of application No. PCT/JP2013/058414, filed on Mar. 22, 2013.

(30) Foreign Application Priority Data
Dec. 28, 2012 (JP) 2012-288889

(51) Int. Cl. H04N 21/25; H04N 21/6338

(52) U.S. Cl. CPC H04N 21/251; H04N 21/6338
USPC 725/116

(57) ABSTRACT

According to one embodiment, an information management device includes a generator, a storage module, a structuring module, a retrieval module, and a result notification module. The generator generates a characteristic quantity of a reproduction content. The storage module stores the generated characteristic quantity. The structuring module generates structure information by dividing a single reproduction content into a plurality of reproduction intervals based on the generated characteristic quantity and by structuring the reproduction content by taking into account a time sequence of the reproduction intervals of the reproduction content that is being reproduced. The reproduction content is structured by the reproduction intervals. The retrieval module retrieves a related content based on the structure information. The result notification module notifies the retrieval result of the related content.

### CROSS-REFERENCE TO RELATED APPLICATIONS

This application is a continuation of PCT international application Ser. No. PCT/JP2013/058414 filed Mar. 22, 2013 which designates the United States, incorporated herein by reference, and which claims the benefit of priority from Japanese Patent Application No. 2012-288889, filed Dec. 28, 2012, the entire contents of which are incorporated herein by reference.

### FIELD

Embodiments described herein relate generally to an information management device, a server, and a control method.

### BACKGROUND

Conventionally, there has been proposed a technique to accumulate content data, to store content reproduction history, to recommend to a user content data that sufficiently reflects preference of the user from among content data in a large amount of accumulated content data based on the stored reproduction history.

However, since the conventional technique is performed based on the content reproduction history of a user, range of recommendation does not expand to contents that has never been reproduced by the user, even when such contents are within the user's preference. Therefore, it had been difficult to recommend to a user a content that surprises the user or that provides the user with some expectations.

### BRIEF DESCRIPTION OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary block diagram of a schematic configuration of a viewing information management system according to a first embodiment;

FIG. 2 is an exemplary functional block diagram of a content reproduction terminal device and a server in the first embodiment;

FIG. 3 is an exemplary flowchart of a characteristic quantity extraction process in the first embodiment;

FIG. 4 is an exemplary flowchart of a structuring process in the first embodiment;

FIG. 5A is an exemplary explanatory diagram of sequential changes in a content reproduction in the first embodiment;

FIG. 5B is an exemplary diagram illustrating an example of structuring a group of shots in a tree shape based on the content reproduction result illustrated in FIG. 5A, in the first embodiment;

FIG. 6 is an exemplary explanatory diagram illustrating the structuring based on content reproduction histories of a plurality of users in the first embodiment;

FIG. 7 is an exemplary explanatory diagram illustrating an example of a case in which, when the same screen is displayed more than once during content reproduction (viewing), the screens are handled without taking into account the order thereof, in the first embodiment;

FIG. 8 is an exemplary flowchart of an index generating process in the first embodiment;

FIG. 9 is an exemplary explanatory diagram illustrating an example of a browse screen of a content reproduction history (viewing history) in the first embodiment;

FIG. 10A is an exemplary explanatory diagram illustrating an example of a display screen when a slideshow is performed, in the first embodiment;

FIG. 10B is an exemplary explanatory diagram illustrating an example of displaying of a retrieval result in the first embodiment;

FIG. 11A is an exemplary explanatory diagram illustrating a manner of accumulating in a server all characteristic quantities quantities generated when each of a plurality of users reproduces contents, according to a second embodiment;

FIG. 11B is an exemplary explanatory diagram illustrating a display example of a screen for recommending a user who has a similar viewing tendency based on a viewing history, in the second embodiment;

FIG. 11C is an exemplary explanatory diagram illustrating a display example of a screen for retrieving and recommending a similar content that has never been viewed by the user in the past, i.e., an unviewed related content, by using a characteristic quantity of a content, in the second embodiment;

FIG. 12A is an exemplary explanatory diagram illustrating an example of recommending a user in accordance with a progress status (progress condition of viewing) of a content reproduction, in the second embodiment; and

FIG. 12B is an exemplary explanatory diagram illustrating a display example of a screen for recommending a user in accordance with a progress status (progress condition of viewing) of a content reproduction, in the second embodiment.

### DETAILED DESCRIPTION

In general, according to one embodiment, an information management device comprises a generator, a storage module, a structuring module, a retrieval module, and a result notification module. The generator is configured to generate a characteristic quantity of a reproduction content. The storage module is configured to store the generated characteristic quantity. The structuring module is configured to generate structure information by dividing a single reproduction content into a plurality of reproduction intervals based on the generated characteristic quantity and by structuring the reproduction content by taking into account a time sequence of the reproduction intervals of the reproduction content that is being reproduced. The reproduction content is structured by the reproduction intervals. The retrieval module is configured to retrieve a related content based on the structure information. The result notification module is configured to notify the retrieval result of the related content.

Next, embodiments will be described with reference to the drawings.

### First Embodiment

In a first embodiment, an explanation is made assuming a system in which a television as a content reproduction terminal device is capable of displaying and reproducing data input via various routes such as broadcast waves, an external connection device, a network, and the like.

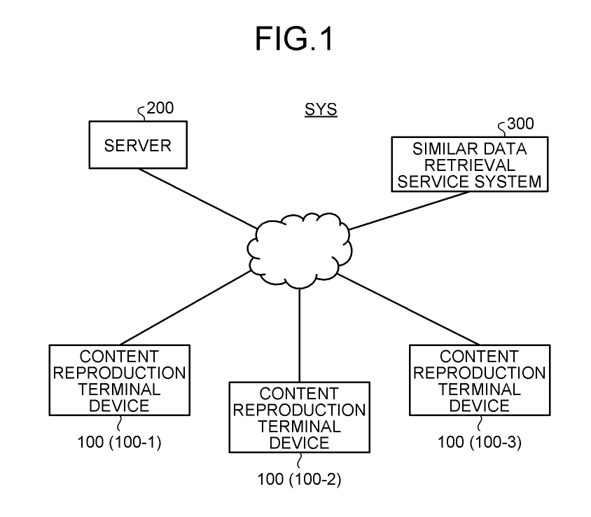

FIG. 1 is a block diagram of a schematic configuration of a viewing information management system of the embodiment.

The viewing information management system SYS includes: a content reproduction terminal device 100 that reproduces a content; a server 200 that manages a characteristic quantity of a content reproduced by the content reproduction terminal device 100 and provides various services based on the characteristic quantity of the content; a similar data retrieval service system 300 that provides service of retrieving similar data; and a communication network NT, such as the Internet, that connects the content reproduction terminal device 100 with the server 200 or the similar data retrieval service system 300.

Here, the content reproduction terminal device 100 is configured as a television, a recorder with a tuner, a personal computer, a mobile information terminal device such as a smartphone, a game machine, and/or the like.

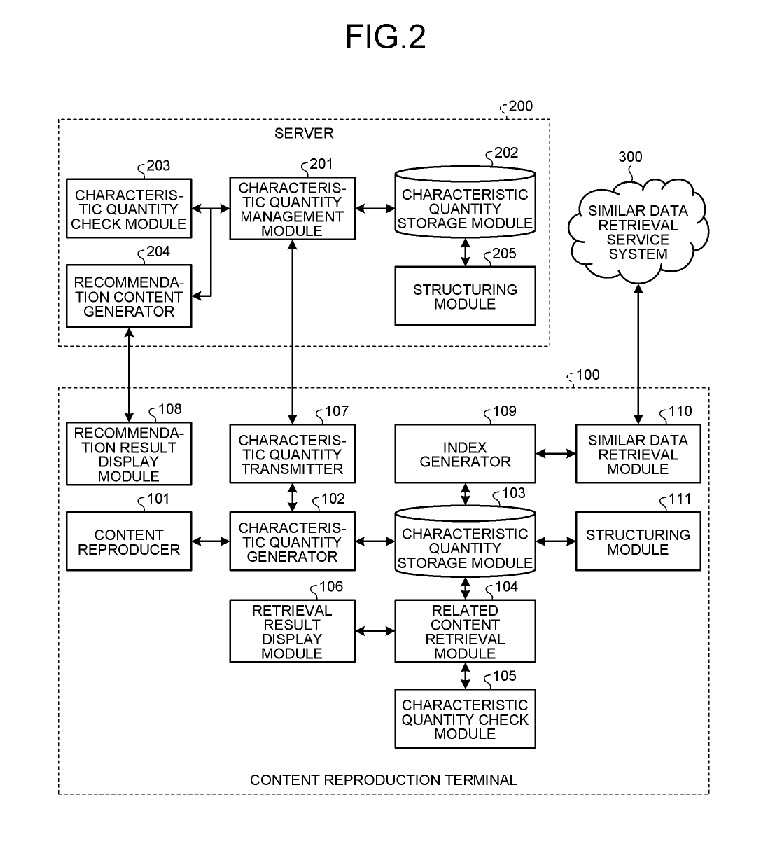

FIG. 2 is a functional block diagram of the content reproduction terminal device and the server.

The content reproduction terminal device 100 includes: a content reproducer 101 that reproduces a content; a characteristic quantity generator 102 that generates a characteristic quantity from contents which has being reproduced; reproduced; a characteristic quantity storage module 103 that stores the content characteristic quantity generated by the characteristic quantity generator 102; and a related content retrieval module 104 that retrieves a related content based on the characteristic quantity stored in the characteristic quantity quantity storage module 103.

The content reproduction terminal device 100 further includes: a characteristic quantity check module 105 that checks the characteristic quantity when the related content retrieval module 104 retrieves a related content; a retrieval result display module 106 that displays a retrieval result of the related content retrieval module 104; a characteristic quantity transmitter 107 that transmits the characteristic quantity generated by the characteristic quantity generator 102 to the server 200 via the communication network NT; and a recommendation result display module 108 that receives recommendation content data transmitted from the server 200 and displays the recommendation result of the server 200.

The content reproduction terminal device 100 further includes: an index generator 109 that generates an index based on the characteristic quantity upon storing the characteristic quantity in the characteristic quantity storage module 103; a similar data retrieval module 110 that retrieves similar data together with the similar data retrieval service system 300 via the communication network NT when the index generator 109 generates an index; and a structuring module 111 that performs structuring to indicate a relationship between reproduced contents based on the characteristic quantity stored in the characteristic quantity storage module 103.

The server 200 includes: a characteristic quantity management module 201 that manages the characteristic quantity transmitted from the content reproduction terminal device 100; a characteristic quantity storage module 202 that stores therein the characteristic quantity transmitted from the content reproduction terminal device 100; and a characteristic quantity check module 203 that checks between the characteristic quantities already stored in the characteristic quantity storage module 202, or between the characteristic quantity already stored in the characteristic quantity storage module 202 and a characteristic quantity newly transmitted from the content reproduction terminal device 100.

The server 200 further includes: a recommendation content generator 204 that generates a content that should be recommended to a user of the content reproduction terminal device 100 or generates a recommendation content for recommending other users or the like to the user, under the control of the characteristic quantity management module 201 and based on the result of checking the characteristic quantities; and a structuring module 205 that performs structuring to indicate a relationship between the reproduced contents based on the characteristic quantity stored in the characteristic quantity storage module 202.

For better understanding, the following example assumes an environment in which a television is used to display a screen or to output a sound. For example, cases such as when a program is viewed by a television, when a video is viewed, when contents on the Internet is viewed, when a slideshow of images stored in a digital camera is displayed, or when a game is played on a home game machine, are assumed.

The system to be described below under the above-mentioned environment enables central management regardless of types of a connected device or a view content so as to browse and display a viewing history, to search a related content, or to search a user who views a similar content, regardless of media or contents. The present embodiment will be described by assuming that the content reproduction terminal device 100 is a television, but the embodiment is not limited thereby.

Next, an operation of the embodiment will be described.

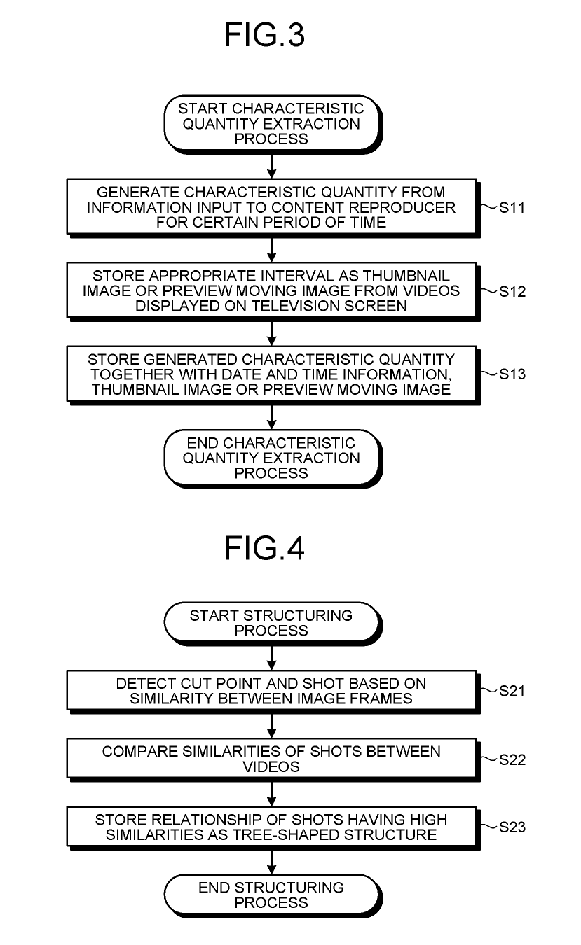

FIG. 3 is a flowchart of a characteristic quantity extraction process.

When a user reproduces and views a content on a television, the characteristic quantity generator 102 of the content reproduction terminal device 100 generates a characteristic quantity from information received during a certain time period (a predetermined sampling period) in accordance with the reproduction of the content by the content reproducer 101 (S11).

Here, the generated characteristic quantity may be a characteristic quantity that can be calculated for each image frame, for example. For example, gradation of three primary colors (RGB) of each pixel, gradation of brightness (Y) of each pixel, gradation of brightness-red color difference (Cr), gradation of brightness-blue color difference (Cb), histograms of each pixels in a horizontal direction and vertical direction, and the like, can be considered.

Further, by using a function for detecting a human face as well, advanced information such as information on correspondence between a size of a face area and its position, may be generated as the characteristic quantity.

Still further, the characteristic quantity may be calculated not by each frame, but may be calculated by a plurality of frames or by frames received during a predetermined time period.

When a reproduction content includes sound, a power orbit rate at each unit time, a pitch or a Mel-frequency cepstrum coefficient (MFCC) at each unit time duration may be generated as the characteristic quantity.

Still further, a characteristic quantity covering video and sound may be generated.

Further, in addition to the video content, a resolution, an encoding method (such as MPEG-2 and H.264), a broadcast system (such as NTSC and PAL), and an input terminal number or model (such as HDMI) can be used as the characteristic quantity. Further, information of a device identifier or a device type of an external device connected to an input terminal (information that indicates a type of a game machine, a DVD player, or the like) may be obtained and used as the characteristic quantity.

Further, what kind of operation is done while a screen is displayed may be used as the characteristic quantity.

The above explanation is provided only as an example of the characteristic quantity, and a characteristic quantity to be generated and a method for generating the characteristic quantity are not limited thereto.

Next, the content reproduction terminal device 100 stores a thumbnail image or a preview moving image corresponding to an appropriate interval from videos (contents) displayed on the television screen, in the characteristic quantity storage module 103 (S12).

Then, the content reproduction terminal device 100 associates the characteristic quantity generated at S11 with the thumbnail image or preview moving image stored at S12, and stores the characteristic quantity and the thumbnail image or the preview moving image therein (S13).

Next, a content structuring process based on the extracted characteristic quantity will be described.

FIG. 4 is a flowchart of a structuring process.

First, the structuring module 111 of the content reproduction terminal device 100 detects cut points and shots based on a similarity between image frames corresponding to the characteristic quantities stored in the characteristic quantity storage module 103 (S21).

The cut points are detected by the structuring module 111 by calculating a similarity between an image frame input by each frame and an image frame input right before and by detecting an image change point at which the image content changes. Further, when a moving image using a predictive coding for image compression such as an MPEG-2 is used, the cut points may be detected using a variation of predictive coding amount. Here, the detection method of the cut points is not limited to the above method and may be realized by various known methods (for example, see Japanese Patent Publication Laid-open No. H9-93588).

The structuring module 111 then detects, as a shot, a collection of image frames belonging to a time interval between two cut points in a temporally closest positions detected in the cut point detection. In other words, the videos constituting each content is made as a line of shots.

Next, the structuring module 111 compares the similarities of shots (between shots) between a plurality of contents (among a plurality of videos) (S22).

Then, the structuring module 111 stores, as a tree structure, relationship between the shots with high similarities (S23).

In this manner, according to the present embodiment, an image at a certain point is not simply stored as the characteristic quantity, but the contents (shots) displayed on the content reproduction terminal device 100 are managed also with reference to time. Therefore, information that indicates process or progress of the content reproduction, for example, how far the content is already viewed, can be obtained and stored.

Here, an example of structuring will be described.

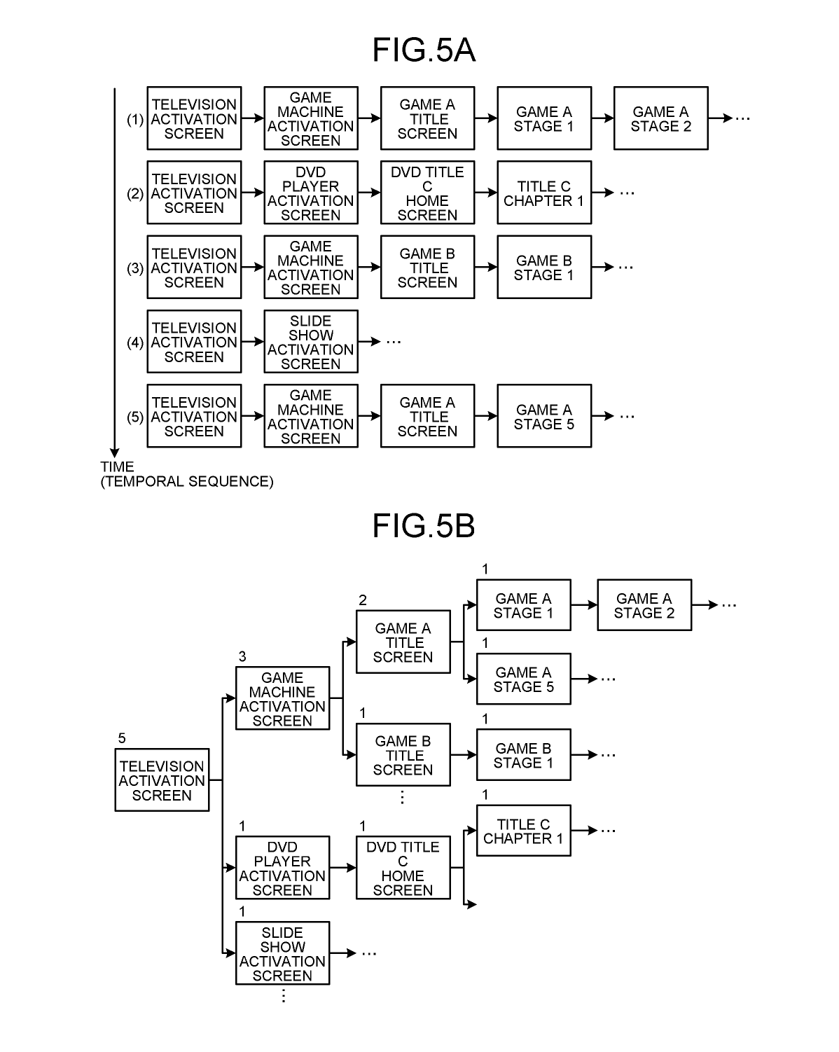

FIG. 5A is a diagram explaining sequential changes in a content reproduction.

FIG. 5A explains an example of a case in which various viewing operations such as a game, a DVD reproduction, a slideshow, are performed on the television after the television is activated.

In this case, a calculation of a characteristic quantity of each screen constituting the series of the content reproduction is performed, in every certain period of time, for the entire screen and for a video interval of a certain period of time. Here, the calculation timing (calculation unit) of the characteristic quantity may be methods for calculating every time when there is a major change in the screen, calculating every one frame, or calculating the characteristic quantity after performing a normalization process for absorbing a difference in screen resolution.

As illustrated in FIG. 5A, during the content reproduction, the screen of “television activation” first appears commonly regardless of the reproduced content.

Then, upon playing game, a viewing history going through the common screen can be obtained such that, the common screen is followed by a game machine activation screen, and then, a title screen of each game, game content, and the like follow thereafter in this order.

Further, upon reproduction of a DVD, a viewing history going through the common screen can be obtained such that, the screen of “television activation” is followed by a DVD player activation screen, and then, a DVD title home screen, a chapter screen, and the like follow thereafter in this order.

Further, upon reproduction of a slideshow, a viewing history going through the common screen can be obtained such that, the “television activation” screen is followed by a slideshow activation screen, and then, a transition to a slide screen configuring the slideshow follows thereafter.

Thus, it can be considered to perform the structuring by the common screen and the transitions from the common screens. Therefore, the structuring is performed based on the similarity between the shots among a content-based video group.

Here, the similarity between the shots can be measured by selecting and comparing one or more frames in each shot. In more detail, for example, a method disclosed in Japanese Patent Publication Laid-open No. H9-270006 can be used. According to the method disclosed in Japanese Patent Publication Laid-open No. H9-270006, characteristic quantities for two respective target frames are calculated and the distance between the two characteristic quantities are calculated. For example, when a characteristic quantity using an angle histogram is employed, a distance between the two characteristic quantities in a 36 dimensional space is calculated. This distance is a value corresponding to the similarity, and the smaller distance value indicates the higher similarity.

Thus, by correcting shots having high similarities and considered to have similar (or the same) scene, the shot group can be structured.

FIG. 5B is a diagram illustrating an example of structuring a group of shots in a tree shape based on the content reproduction result illustrated in FIG. 5A.

The number marked at the upper left of the squares indicates the number of times each screen is displayed (or may be the displayed time).

The number of equal to or more than two marked at the upper left of the frame that represents the screen indicates that the screen has been displayed in a number of content reproductions.

Thus, in each level of hierarchy under a level of hierarchy of the “television activation” screen as a root, display screens of used devices, game titles, DVD titles are hierarchically structured.

Further, while each content such as a game, a DVD, or the like are being produced, the level of hierarchy are branched according to the progress of the reproduction.

Thus, by referring to the tree structure of the group of shots and recognizing the screen transitions, it becomes possible to obtain information such as, with which content reproduction device the reproduction is performed, which content (a game, for example) is reproduced, the reproduction progress of the content (how far reproduced or how far proceeded), or the like.

Here, it is difficult to structure the screen displayed for only once. Thus, it can be considered to perform structuring by sharing a characteristic quantity obtained in content reproductions of another user.

For example, in FIG. 5B, “Game A, Stage 1” and “Game A, Stage 2” are both displayed once, so it is difficult to automatically (by computer processing) and directly distinguish the stages.

However, it is possible to distinguish the shots when a content reproduction history of another user including a structuring result of a group of shots (or a characteristic quantity extraction result) is also referred.

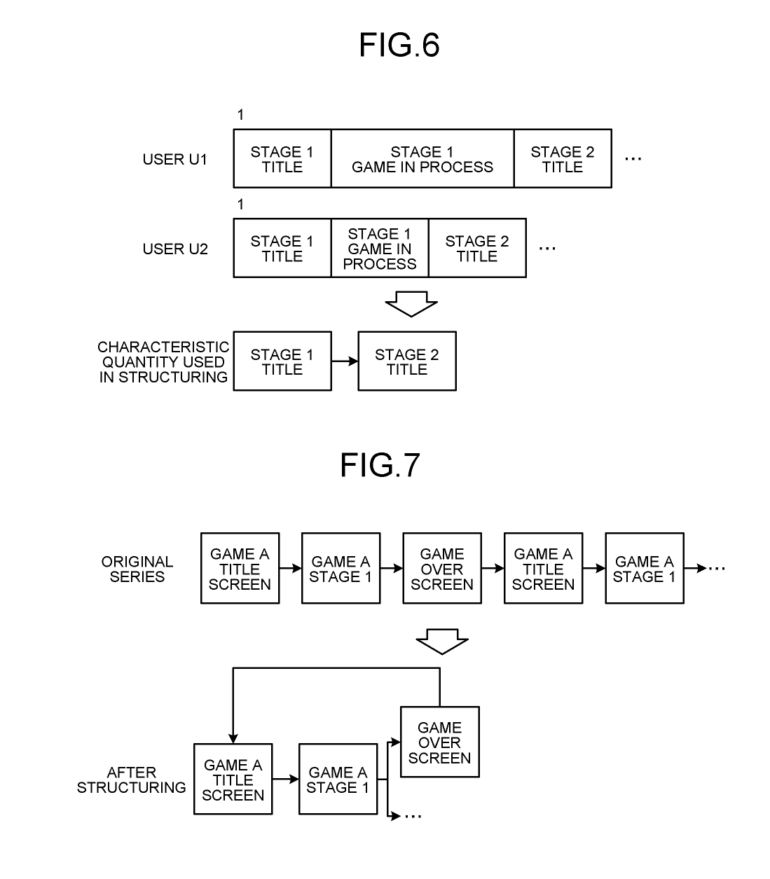

FIG. 6 is a diagram explaining the structuring based on content reproduction histories of a plurality of users.

For example, as illustrated in FIG. 6, regarding the same game, it is possible to extract a start screen of “Stage 1” and a start screen of “Stage 2” as the common screen based on reproduction histories of a user U1 and a user U2 who played “Stage 1” and “Stage 2” in separate reproductions or a difference of screens in each stage.

Here, a user cannot read the shots such as “Stage 1” when the shot is merely structured. However, as described below, by associating a thumbnail image, a preview moving image, or an index text with each shot, the user will be able to browse and operate the shots via a user interface.

As described above, the present embodiment used tree-shaped structuring; however, the transitions of the common screens maybe structured in a graph, or maybe structured by using other structuring methods.

If the same screen is repeatedly displayed in a single content reproduction (viewing), there may be two cases: a case in which they are handled as different screens while taking into account their order; and a case in which they are handled as the same screen while not taking into account their order.

FIG. 7 is a diagram explaining an example of a case of handling screens displayed for more than once in a content reproduction (viewing) as the same screen, while not taking into account their order.

For example, it corresponds to a case in which, if the content is something like a game, the same screen is repeatedly and cyclically displayed. In more detail, it corresponds to a case in which a stage cannot be beaten, and a game over screen is repeatedly displayed as a result.

In such a case, by handling the screens as the same screen while not taking into account their order, the structure of reproduced contents can be simplified and the structure of reproduced contents can be easily handled.

Further, it corresponds to a case in which the order of image frames or shots is not fixed, such as a case a plurality of photos are displayed as a slideshow in a predetermined order, for example.

In such a case, it may be possible to properly perform the structuing by displaying the same slideshow for a number of times; however, the same slideshow cannot always be displayed for a number of times.

Thus, it can be considered that, by detecting that the display content of the content reproduction is the still image at the time of the cut point detection, the shots are deemed as the slideshow or as a group of still images and not as the videos.

As a method for detecting the still image, an interval during which there is almost no change in a characteristic quantity for equal to or more than a certain period of time or for a certain number of frames can be detected at the time of detecting the cut points.

Further, as a method for detecting the slideshow, it can be considered to specify a case in which the still images detected by the aforementioned method sequentially appear as the slideshow.

In this manner, the information related to the content reproduction is associated with the characteristic quantity and stored, and the information is browsed, retrieved, and displayed. Consequently, the information can be reused.

Here, if the reproduced information is a content having no image such as sound, a thumbnail image is not created or a predetermined image corresponding to the input terminal is used. Or, an image is not allocated but a distinguishable label such as a file name may be allocated.

Then, from the videos displayed on the screen, a appropriate reproduction interval (corresponding to a shot or a plurality of shots) is registered as the thumbnail image or the preview moving image. The generated characteristic quantity is registered as being associated with viewed date and time, and the thumbnail image or the preview moving image.

In the above described process, a structured content reproduction history (viewing history) is stored. However, a user might not be able to read the structured content reproduction history obtained from the aforementioned process, as the text information.

It is thus considered to obtain the text information used in the index by using similar data retrieve service of the external external similar data retrieval service system 300.

Hereinafter, a method for obtaining the text information to be used as an index of each image based on the image will be described.

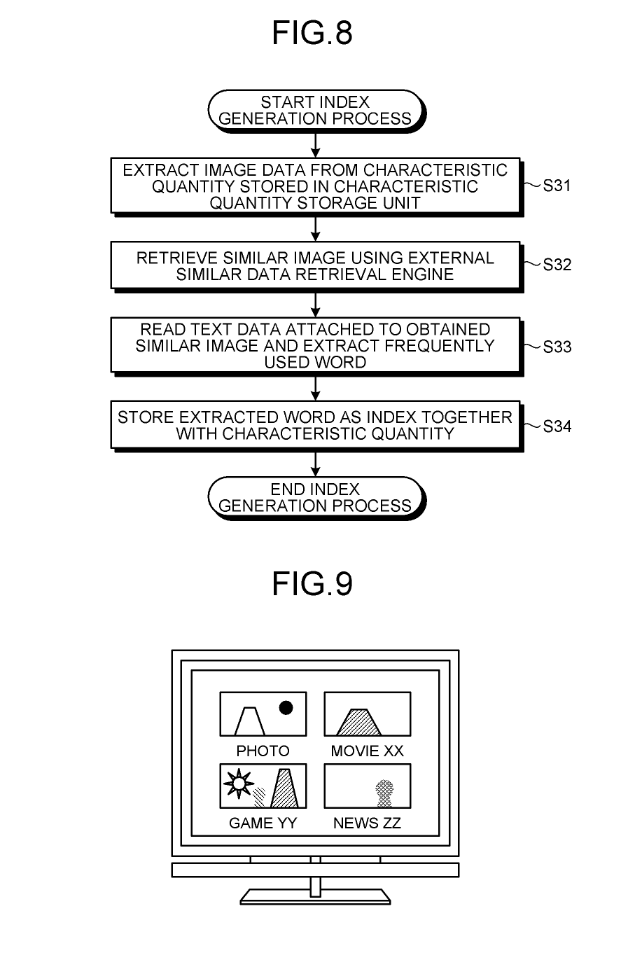

FIG. 8 is a diagram illustrating a flowchart of an index generation process.

First, the index generator 109 extracts image data corresponding to a thumbnail image or a preview moving image from the data stored in the characteristic quantity storage module 103 (S31).

Next, the index generator 109 controls the similar data retrieval module 110, and retrieves a similar image in the external similar data retrieval service system 300 (S32).

Then, the index generator 109 obtains a frequently used word as text data from text attached to the similar image as metadata (for example, text information written near the image when the image is in a web page) obtained as a retrieval result (S33).

In particular, the text attached to the similar image obtained as the retrieval result is analyzed by a morphological analysis, and a frequently used proper name is obtained as the text data.

In this manner, the index generator 109 stores the word corresponding to the obtained text data by associating the word with the characteristic quantity stored in the characteristic quantity storage module 103 to use as a text of an index (S34).

The above description describes a case originated in an image; however, a method using another media such as sound and the like or a characteristic quantity may be used in the system. Further, in the similar image retrieval in S32, a similar image may be retrieved from a narrowed database after narrowing the database according to another characteristic quantity data corresponding to the image data. In other words, for example, when an image is input to the content reproduction terminal device 100 from a game machine via an input terminal and an index is generated based on the image, the index generator 109 controls to retrieve from a range of database related to the game machine. Then, when the database is narrowed, for example, the image data may be determined as data related to the game machine based on a device type information or a device identification information of the game machine to narrow the database related to the game machine.

Further, when metadata is associated with the displayed content itself, data in the metadata may be applied. As an example of metadata, there are an electronic program guide (EPG), an exchangeable image file format (EXIF), a file name, or the like.

Further, when information for referring to another resource such as a unique resource identifier (URI) is attached as the metadata, the text information included in the referred resource may also be used.

After the above processes are performed, the user can use the content reproduction history.

FIG. 9 is an explanatory diagram of an example of a browse screen of the content reproduction history (viewing history).

As illustrated in FIG. 9, on the content reproduction history browse screen, information related to an already reproduced content, more specifically, a content reproduction history indicating that a photo, a movie, a game and news have been viewed is displayed.

In this manner, a history of viewed and browsed contents using various devices can be displayed integrally.

Further, on the browse screen of the content reproduction history, one or more index (a content name, for example) is applied to each structured content.

Here, as a method for providing the index, various methods can be used. For example, a method in which a user directly provides an index using a user interface of a terminal, a method for retrieving information that matches or is similar to the characteristic quantity of the content and employing attached text data as an index (tag) of the content indicating the characteristic quantity, and the like, can be used.

For example, when an image is used as the characteristic quantity, a content such as a web page including a similar image is retrieved by using a similar image retrieval service on the Internet, and a frequently used or characteristic word is extracted from text included in the retrieval result to apply as an index of the image.

Further, a classification such as a game, a nature photo, sports, or the like may be applied according to the meaning of the word constituting the applied index. In this manner, the classification can be used as a condition to narrow when retrieving the content.

Further, when an index is applied to a user's content and the index is shared with another user via a server or the like, the same index can be applied to the content of another user having the same characteristic quantity.

For example, on a screen to edit an index, indexes applied by other users are presented as candidates and one of them may be selected or an index that equal to or more than a certain number of user applied may be automatically applied.

Here, the screen to apply an index is not limited to a screen to browse history and can be any screen that allows to distinguish contents or content structures.

The above description describes a case of browsing a reproduction history of already reproduced contents; however, it can be made to browse a reproduction history of contents related to a content which is currently being reproduced.

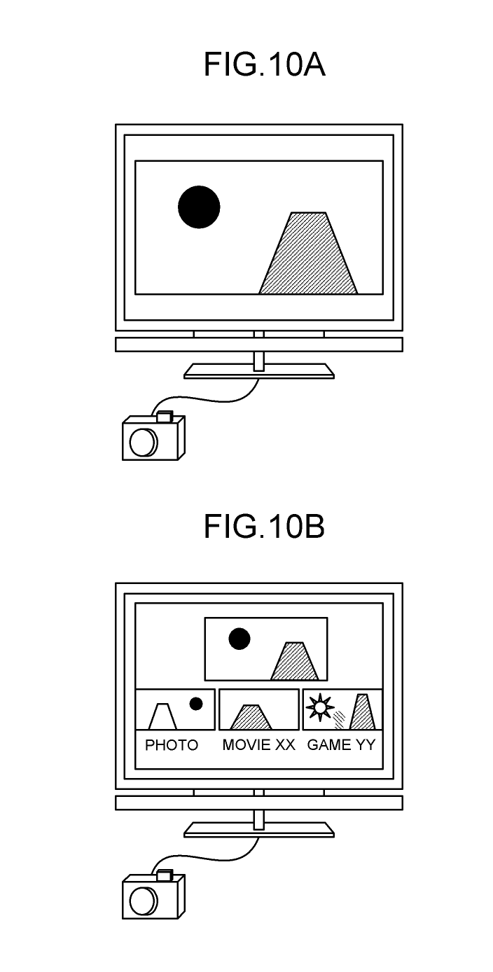

FIGS. 10A and 10B are explanatory diagrams of a case of retrieving or browsing a related content which is related to a content being reproduced.

Here, a case will be described in which an image (photo) taken by a digital camera is displayed in a slideshow using a television as a content reproduction device by using the digital camera as an external input device.

FIG. 10A is an explanatory diagram of an example of a display screen when the slideshow is performed.

As illustrated in FIG. 10A, when the user operates a “related content retrieval” on the television as the content reproduction terminal device 100 while a photo (image) is displayed in the slideshow, related contents are retrieved and displayed based on the characteristic quantity of the currently displayed image.

FIG. 10B is an explanatory diagram of an example of displaying of a retrieval result.

On the display screen of the content reproduction terminal device 100, as originated in the photo (image) of the digital camera taken by the user, a retrieval result from different media such as a movie scene, a game display, or the like is obtained and displayed in addition to another photo.

As described above, according to the first embodiment, a content with a greater relevancy can be retrieved because a reproduced content is divided into a plurality of reproduction intervals based on a generated characteristic quantity, the reproduced content is structured in every reproduction interval (shot) in consideration of a sequential order of the reproduction intervals of the reproduced content during a reproduction, structure information is generated, and a related content is retrieved based on the structure information.

### Second Embodiment

The first embodiment is related solely to a process of a single content reproduction terminal device (television) or a single user. On the other hand, a second embodiment is an embodiment for making use of characteristic quantities of another television or another user by storing an obtainied characteristic quantitiy in the server 200 and by comparing the characteristic quantities of the another television or the another user.

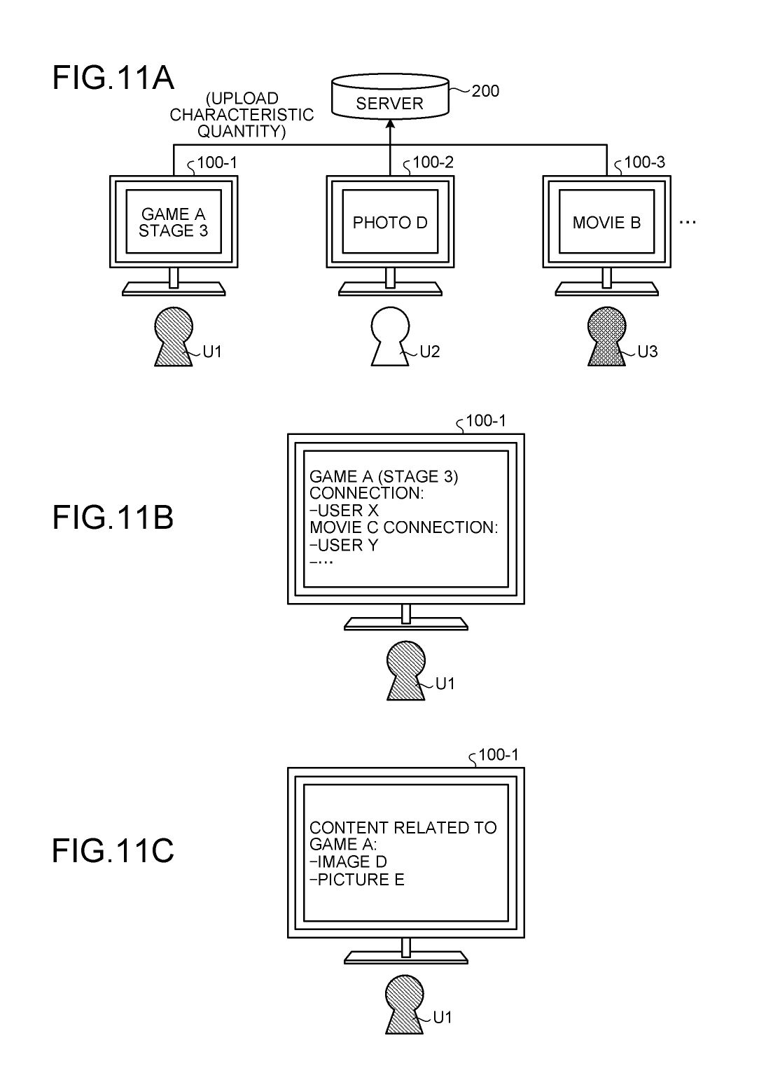

FIGS. 11A to 11C are operation explanatory diagrams of a case in which there are a plurality of users using a plurality of content reproduction terminal devices, respectively.

According to the second embodiment, while the users using the content reproduction terminal devices, respectively, are randomly reproducing (viewing) contents, another user or another content is recommended according to the content reproduction condition.

FIG. 11A is a diagram explaining a manner of storing, to a server, all characteristic quantities generated when respective users reproduce contents.

In other words, the characteristic quantity storage module 202 of the server 200 stores characteristic quantities transmitted from the content reproduction terminal devices 100-1 to 100-3 under the control of the characteristic quantity management module 201.

In parallel with this process, the structuring module 205 performs structuring to represent a relationship between reproduced contents based on the characteristic quantities stored in the characteristic quantity storage module 202.

At this time, the characteristic quantities are associated with the respective users U1 to U3 or the respective content reproduction terminal devices 100-1 to 100-3, and stored.

Subsequently, in the server 200, a recommendation function is used.

First, the characteristic quantity check module 203 checks between the characteristic quantities already stored in the characteristic quantity storage module 202 or between the characteristic quantity already stored in the characteristic quantity storage module 202 and a characteristic quantity newly transmitted from the content reproduction terminal device 100.

With this, the recommendation content generator 204 generates a content to be recommended to a user of the content reproduction terminal device 100, a content for recommending other uses, or the like, based on the result of checking the characteristic quantity by the characteristic quantity check module 203 and under the control of the characteristic quantity management module 201.

FIG. 11B is an explanatory diagram of a display example of a screen of when a user having a similar viewing tendency tendency is recommended based on a viewing history.

Here, as a method of recommendation, a typical collaborative filtering system may be used. In addition to a recommendation using all viewing contents, it may be considered to perform a recommendation according to preferences of each device by executing a recommendation function in each device.

Further, by using a characteristic such as a content browsing range or a game progress obtained in the above described method, a recommendation function in a more specific range than a conventional content unit such as “recommending only a person who has proceeded to Stage 3 in Game XX,” “SNS (Social Networking Service) of a person who has beaten Game XX” or the like can be realized.

Further, when “a list of people who has finished viewing content not yet viewed by the user,” “a list of people who proceeds further in the game than the user ” or the like is obtained and a blog information or an ID of a social media is associated to the user, so-called “spoiler,” that is, information that the user has not seen and should not see is accidentally disclosed, can be prevented by filtering information published from the person.

In the case of FIG. 11B, as an illustrative example, regarding a relevance (connection) of “Stage 3” that is a reproduction status (progress of the game) of “Game A” which the user U1 is reproducing, a user X reproducing the same stage “Stage 3” is recommended, or regarding a relevance (connection) of “Movie C,” which the user U1 has reproduced, a user Y who reproduced the same “Movie C” is recommended.

Further, FIG. 11C is an explanatory diagram of a display example of a screen of when retrieving and recommending a similar content which the user has not viewed in the past, that is, an unviewed related content by using a characteristic quantity of a content.

In the case of FIG. 11C, as an illustrative example, regarding a related content of “Game A” that the user U1 is reproducing, “Image D” and “Picture E” are recommended.

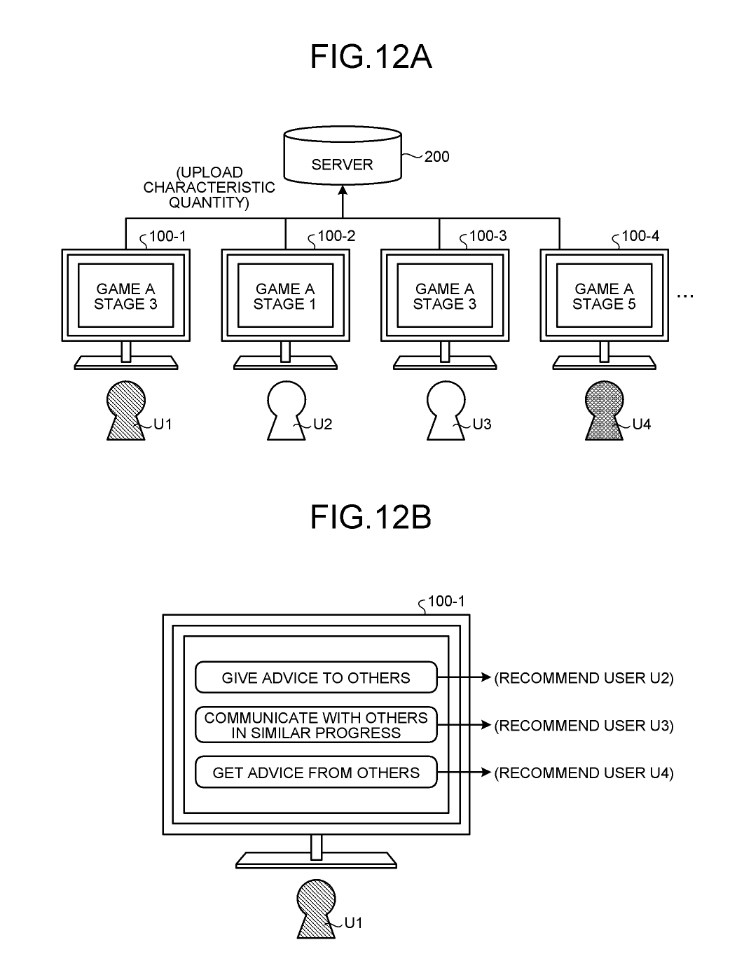

FIG. 12A is a diagram explaining an example of recommending a user corresponding to a progress status (progress condition of viewing) of a content reproduction.

FIG. 12B is an explanatory diagram of a display example of a screen when recommending a user corresponding to a progress status (progress condition of viewing) of a content reproduction.

In a condition that the users U1, U2, U3 and U4 are proceeding to Stages 3, 1, 3 and 5, respectively, in the same Game A, as a menu in a user recommendation, for example, options such as “Give advice to others,” “Communicate with others in similar progress,” and “Get advice from others” are displayed.

In this case, regardless of whether an index is being applied, a user recommendation can be performed such that the users U2, U3 and U4 are respectively recommended to the user U1 according to the progress status (progress condition of viewing) of the content reproduction.

In this manner, the usage of a progress status (progress condition of viewing) of the content reproduction allows a content recommendation or a product purchase recommendation between users of different contents or media.

For example, when music from the Movie B is used as BGM (Back Ground Music) in a particular stage in the Game A, it can be considered to recommend the Movie B, a soundtrack compact disc (CD) or a digital versatile disc (DVD) of the Movie B to a user who has reached the stage. Or, when a certain number of people among those who viewed a particular scene of the Movie B also see a parody video E, the video E may be recommended.

As described above, by the use of the characteristic quantities stored via the content reproduction terminal devices 100-1 to 100-3, the contents input from a plurality of devices or media can be integrally handled and a greater variety of applications and services can be obtained.

As described above, according to the second embodiment, in addition to the effects of the first embodiment, information about related reproduction contents and related users users can be obtained according to reproduction statuses of reproduction contents of each user, and contents can be reproduced reproduced more effectively.

### Modification

The content reproduction terminal device 100 in the above embodiments is described as a device which is built-in a viewing device such as a television. However, it is not limited to this manner as long as it is connected to a device for inputting and outputting pictures and sound. For example, there may be a method to integrally manage, using the suggested system, all the picture and sound information input and output via the adapter device by making this device as an adapter device connected to a picture input terminal.

Or, when targeting the data transmitted via the network, it may be made as a device in the network, such as a router device. Additionally, it may be made as a device to input or output viewing information.

As a result of the above, by applying management information to a content output via the television as the content reproduction terminal device 100, various contents can be integratedly handled.

An information management device of the embodiments includes a controller such as a CPU, a memory such as a read only memory (ROM) and a RAM, an external memory such as an HDD, a CD drive device, a display such as a display device, and an input device such as a keyboard and a mouse, and can be made as a hardware using a normal computer.

A control program executed by the information management device of the embodiments is provided as a file in an installable format or an executable format, and registered in a recording medium such as a CD-ROM, a flexible disk (FD), a CD-R, a digital versatile disc (DVD) and the like that are readable by a computer.

Further, the control program executed by the information management device of the embodiments may be made to be stored in a computer connected to a network such as the Internet and provided as being downloaded via the network. Further, the control program executed by the information management device of the embodiments can be made to be provided or distributed via the network such as the Internet.

Further, the control program of the information management device of the embodiments may be made to be provided by previously installing to the ROM or the like.

The control program executed by the information management device of the embodiments is made in a modular composition including the above described units (the characteristic quantity generator, characteristic quantity storage module, index generator, structuring module, related content retrieval module, characteristic quantity check module, similar data retrieval module, recommendation content generator). As an actual hardware, the CPU (processor) reads program from above memory medium and executes it so that the respective units are loaded to a main memory, and the characteristic quantity generator, characteristic quantity storage module, index generator, structuring module, related content retrieval module, characteristic quantity check module, similar data retrieval module, and recommendation content generator are generated in the main memory.

Moreover, the various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and and changes in the form of the embodiments described herein may be made without departing from the spirit of the inventions. The accompanying claims and their equivalents are intended to cover such forms or modifications as would fall within the scope and spirit of the inventions.

What is claimed is:

1. An information management device comprising:
a generator configured to generate a characteristic quantity of a reproduction content;
a storage module configured to store the generated characteristic quantity;
a structuring module configured to generate structure information by dividing a single reproduction content into a plurality of reproduction intervals based on the generated characteristic quantity and by structuring the reproduction content by taking into account a time sequence of the reproduction intervals of the reproduction content that is being reproduced, the reproduction content being structured by the reproduction intervals;
a retrieval module configured to retrieve a related content based on the structure information; and
a result notification module configured to notify the retrieval result of the related content.

2. The information management device of claim 1, wherein the storage module is configured to store the structure information generated by the structuring module.

3. The information management device of claim 1, comprising an index generator configured to generate an index indicating a content of the reproduction intervals for each reproduction intervals, and to store the index with the characteristic quantity in the storage module.

4. The information management device of claim 1, wherein the result notification module comprises a display module configured to display and notify the retrieval result.

5. The information management device according to claim 1, comprising:
a transmitter configured to transmit the generated characteristic quantity to an external server; and
an information display module configured to display information of a related content or a related user transmitted from the server that has received the characteristic quantity.

6. A server comprising:
a receiver configured to be connected to one or more information management devices of claim 1 via a communication network, and to receive the characteristic quantity in association with a user of each information management device;
a structuring module configured to generate structure information by dividing a single reproduction content into a plurality of reproduction intervals based on the received characteristic quantity and by structuring the reproduction content by taking into account a time sequence of the reproduction intervals of the reproduction content that is being reproduced, the reproduction content being structured by the reproduction intervals;
a relation retrieval module configured to retrieve a related content or a related user based on the structure information corresponding to a plurality of users; and
a result notification module configured to notify the each information management device of the retrieval result of the relation retrieval module as recommendation information.

7. The server according to claim 6, wherein the relation retrieval module is configured to exclude a related content that does not satisfy a predetermined reproduction condition from the retrieval result according to a progress status of the content reproduction of each user.

8. A control method performed by an information management device configured to manage information related to reproduction of a content, comprising:
generating a characteristic quantity of a reproduction content;
storing the generated characteristic quantity;
generating structure information by dividing a single reproduction content into a plurality of reproduction intervals based on the generated characteristic and by structuring the reproduction content by taking into account a time sequence of the reproduction intervals of the reproduction content that is being reproduced, the reproduction content being structured by the reproduction intervals;
retrieving a related content based on the structure information; and
notifying the retrieval result of the related content.

9. A control method performed by a server connected to one or more information management device of claim 1 via a communication network, comprising:
receiving the characteristic quantity in association with a user of each information management device;
generating structure information by dividing a single reproduction content into a plurality of reproduction intervals based on the received characteristic quantity and by structuring the reproduction content by taking into account a time sequence of the reproduction intervals of the reproduction content that is being reproduced, the reproduction content being structured by the reproduction intervals;
retrieving a related content or a related user based on the structure information corresponding to a plurality of users; and
notifying the each information management device of the retrieval result of the relation retrieval module as recommendation information.
